(19) United States
(12) Patent Application Publication
(10) Pub. No.: US 2014/0168778 A1
(43) Pub. Date: Jun. 19, 2014

(54) COMPOSITE GRADED REFRACTIVE INDEX LAYER STRUCTURES AND ENCAPSULATION STRUCTURES COMPRISING THE SAME

(71) Applicant: INDUSTRIAL TECHNOLOGY RESEARCH INSTITUTE, Hsinchu (TW)

(72) Inventors: Chun-Ting CHEN, Bade City (TW); Kun-Wei LIN, Tainan City (TW); Li-Wen LAI, Taichung City (TW)

(73) Assignee: INDUSTRIAL TECHNOLOGY RESEARCH INSTITUTE, Hsinchu (TW)

(21) Appl. No.: 13/730,588

(22) Filed: Dec. 28, 2012

(30) Foreign Application Priority Data
Dec. 19, 2012 (TW) 101148228

(51) Int. Cl. G02B 1/11

(52) U.S. Cl. CPC G02B 1/115
USPC 359/601

(57) ABSTRACT

In an embodiment of the present disclosure, a composite graded refractive index layer structure is provided. The composite graded refractive index layer structure includes a substrate and a composite graded refractive index layer with varying compositions of zinc oxide and silicon oxide formed on the substrate, wherein the composite graded refractive index layer has a first surface where light penetrates thereinto and a second surface where light exits therefrom, and the composite graded refractive index layer has refractive index values which reduce from the first surface to the second surface. The present disclosure also provides an encapsulation structure including the composite graded refractive index layer structure.

### CROSS REFERENCE TO RELATED APPLICATIONS

This application claims priority of Taiwan Patent Application No. 101148228, filed on Dec. 19, 2012, the entirety of which is incorporated by reference herein.

### BACKGROUND

1. Technical Field

The technical field relates to a composite graded refractive index layer structure.

2. Description of the Related Art

Nowadays, electronic products, display products etc., are constantly being developed toward portability, flexibility and speed. Elements of certain electronic and display products are extremely sensitive to water vapor and oxygen. Exposure to an environment of moisture and oxygen will damage the material and shorten the lifespan of such elements.

Packaging is extremely essential to prevent electronic elements from being influenced by moisture and oxygen. The penetration rate of water vapor and oxygen of glass is pretty low. As for packaging, glass is the best option. As for portable products which strictly require a light weight and thin profile, glass is not so appropriate due to fragility and bulk.

It is required to adopt a flexible substrate such as plastic to replace the material of glass to produce flexible electronic or display products with light weight, wearability and windability. The barrier property of water vapor and oxygen of current flexible substrate material is not as good as that of the glass substrate. Therefore, a proper gas barrier treatment on the surface of the flexible substrate material is required to improve the displaying quality and extend the lifespan of the display panel.

A current packaging method is to lower the effect of water vapor on elements through a drying agent. However, under the requirement of the miniaturization, the space of placing a drying agent is getting less and less. Therefore, thin film packaging technology has been developed to replace the drying agent.

Accordingly, how to use thin film packaging technology to isolate electronic or display elements from the external environment, has become a topic of interest to those skilled in the art.

### SUMMARY

One embodiment of the disclosure provides a composite graded refractive index (GRI) layer structure, comprising: a substrate; and a composite graded refractive index layer with varying compositions of zinc oxide and silicon oxide formed on the substrate, wherein the composite graded refractive index layer has a first surface where light penetrates thereinto and a second surface where light exits therefrom. The composite graded refractive index layer has refractive index values which reduce from the first surface to the second surface.

One embodiment of the disclosure provides an encapsulation structure, comprising: a substrate; and a composite graded refractive index layer with varying compositions of zinc oxide and silicon oxide formed on the substrate, wherein the composite graded refractive index layer has a first surface where light penetrates thereinto and a second surface where light exits therefrom. The composite graded refractive index layer has refractive index values which reduce from the first surface to the second surface. An electronic device is disposed on the first surface of the composite graded refractive index layer.

One embodiment of the disclosure provides an encapsulation structure, comprising: a substrate; and a first composite graded refractive index layer with varying compositions of zinc oxide and silicon oxide formed on the substrate, wherein the first composite graded refractive index layer has a first surface where light penetrates thereinto and a second surface where light exits therefrom. The first composite graded refractive index layer has refractive index values which reduce from the first surface to the second surface. An electronic device is disposed between the first surface of the first composite graded refractive index layer and the substrate.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawing, wherein:

FIG. 1 shows a composite graded refractive index (GRI) layer structure according to an embodiment of the disclosure;

FIG. 2 shows a composite graded refractive index (GRI) layer according to an embodiment of the disclosure;

FIG. 3 shows a composite graded refractive index (GRI) layer according to an embodiment of the disclosure;

FIG. 4 shows a composite graded refractive index (GRI) layer according to an embodiment of the disclosure;

FIG. 5 shows a composite graded refractive index (GRI) layer according to an embodiment of the disclosure;

FIG. 6 shows an encapsulation structure according to an embodiment of the disclosure;

FIG. 6-1 shows an encapsulation structure according to an embodiment of the disclosure;

FIG. 7 shows an encapsulation structure according to an embodiment of the disclosure;

FIG. 8 shows an encapsulation structure according to an embodiment of the disclosure;

FIG. 8-1 shows an encapsulation structure according to an embodiment of the disclosure;

FIG. 9 shows light extraction efficiency of OLED encapsulation structures according to an embodiment of the disclosure; and

FIG. 10 shows water vapor transmission rate (WVTR) of a single-layer ZnxSiyOz compound layer with varying ratios of zinc and silicon according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

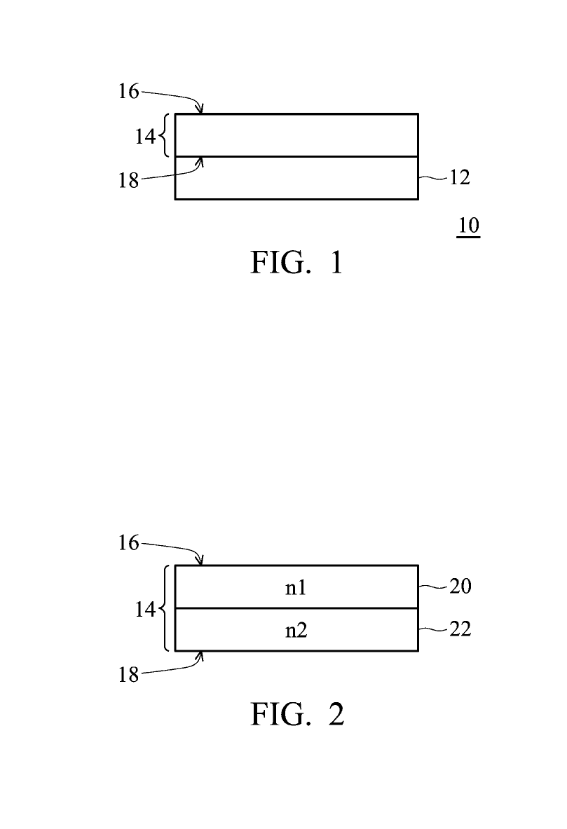

Referring to FIG. 1, in accordance with one embodiment of the disclosure, a composite graded refractive index (GRI) layer structure is provided. A composite graded refractive index (GRI) layer structure 10 comprises a substrate 12 and a composite graded refractive index layer 14. The composite graded refractive index layer 14 is formed on the substrate 12. The substrate 12 may be a glass substrate. The composite graded refractive index layer 14 has a first surface 16 where light penetrates thereinto and a second surface 18 where light exits therefrom. Specifically, the composite graded refractive index layer 14 comprises varying compositions of zinc oxide and silicon oxide, for example, represented by formula ZnxSiyOz (0≦x≦1, 0≦y≦1 and 0<z≦3). Additionally, the composite graded refractive index layer 14 has refractive index values which reduce from the first surface 16 to the second surface 18, ranging from 1.46 to 2.3.

In an embodiment, simultaneously referring to FIGS. 1 and 2, the composite graded refractive index layer 14 comprises a first refractive layer 20 having a first refractive index n1 comprising the first surface 16 where light penetrates thereinto and a second refractive layer 22 having a second refractive index n2 comprising the second surface 18 where light exits therefrom. The first refractive index n1 is larger than the second refractive index n2.

In an embodiment, simultaneously referring to FIGS. 1 and 3, the composite graded refractive index layer 14 comprises a first refractive layer 20 having a first refractive index n1 comprising the first surface 16 where light penetrates thereinto, a second refractive layer 22 having a second refractive index n2 and a third refractive layer 24 having a third refractive index n3 comprising the second surface 18 where light exits therefrom. The first refractive index n1 is larger than the second refractive index n2 and the second refractive index n2 is larger than the third refractive index n3.

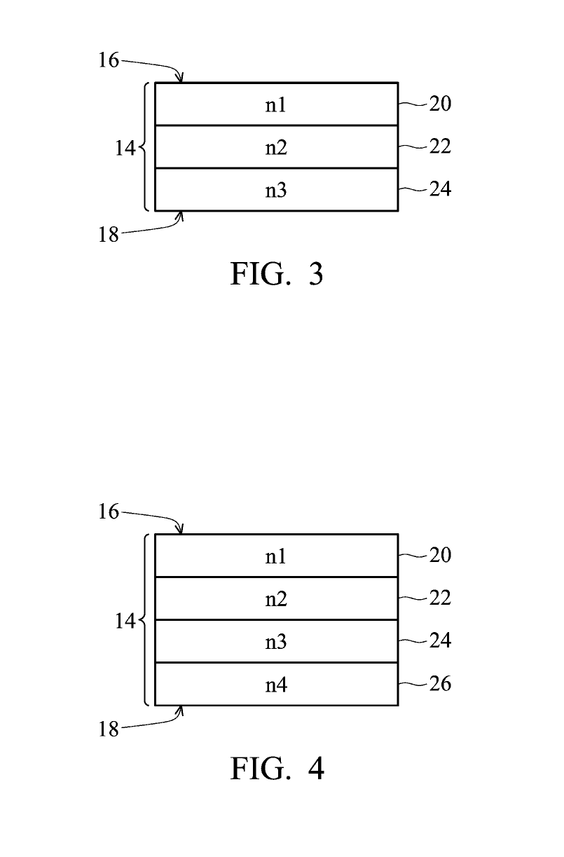

In an embodiment, simultaneously referring to FIGS. 1 and 4, the composite graded refractive index layer 14 comprises a first refractive layer 20 having a first refractive index n1 comprising the first surface 16 where light penetrates thereinto, a second refractive layer 22 having a second refractive index n2, a third refractive layer 24 having a third refractive index n3 and a fourth refractive layer 26 having a fourth refractive index n4 comprising the second surface 18 where light exits therefrom. The first refractive index n1 is larger than the second refractive index n2, the second refractive index n2 is larger than the third refractive index n3 and the third refractive index n3 is larger than the fourth refractive index n4.

In an embodiment, simultaneously referring to FIGS. 1 and 5, the composite graded refractive index layer 14 comprises a first refractive layer 20 having a first refractive index n1 comprising the first surface 16 where light penetrates thereinto, a second refractive layer 22 having a second refractive index n2, a third refractive layer 24 having a third refractive index n3, a fourth refractive layer 26 having a fourth refractive index n4 and a fifth refractive layer 28 having a fifth refractive index n5 comprising the second surface 18 where light exits therefrom. The first refractive index n1 is larger than the second refractive index n2, the second refractive index n2 is larger than the third refractive index n3, the third refractive index n3 is larger than the fourth refractive index n4 and the fourth refractive index n4 is larger than the fifth refractive index n5.

Specifically, the composite graded refractive index layer 14 has a water vapor transmission rate (WVTR) less than 5×10⁻³ g/m²/day.

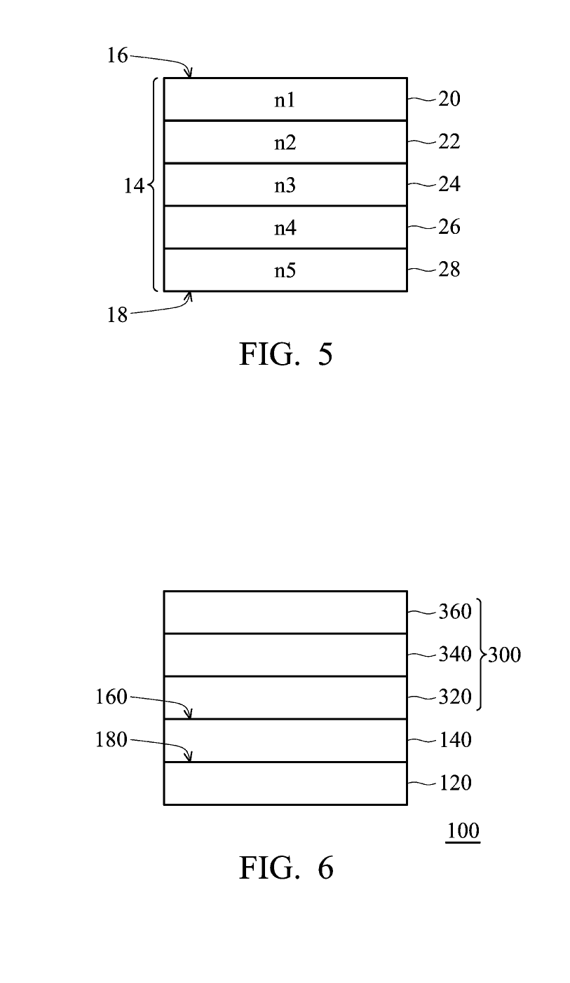

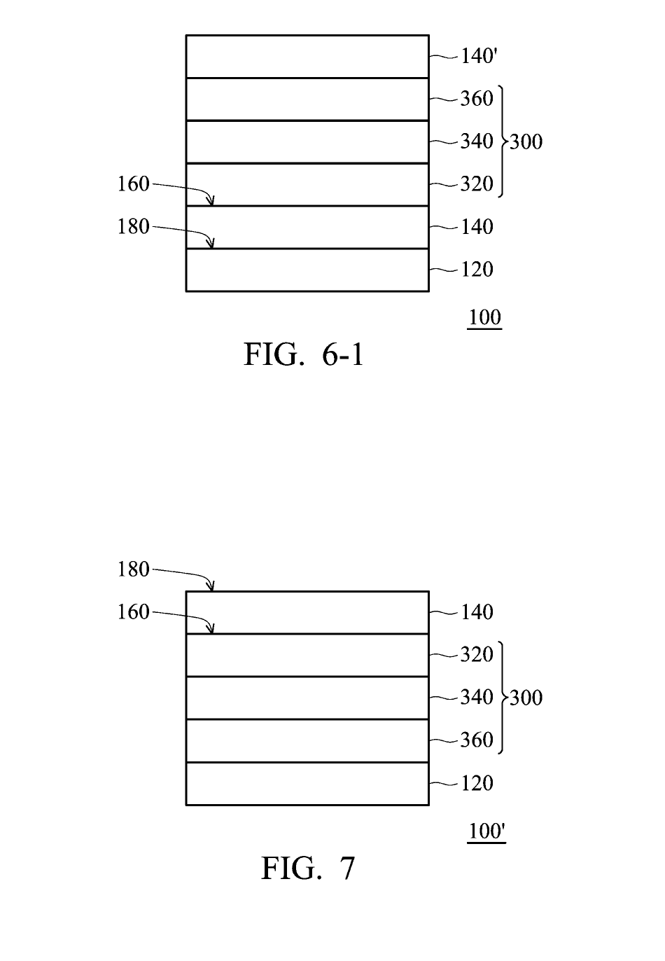

Referring to FIG. 6, in accordance with one embodiment of the disclosure, an encapsulation structure is provided. An encapsulation structure 100 comprises a substrate 120, a composite graded refractive index layer 140 and an electronic device 300. The substrate 120 may be a glass substrate. The composite graded refractive index layer 140 has a first surface 160 where light penetrates thereinto and a second surface 180 where light exits therefrom. The composite graded refractive index layer 140 is formed on the substrate 120. The electronic device 300 is disposed on the first surface 160 of the composite graded refractive index layer 140. Specifically, the composite graded refractive index layer 140 comprises varying compositions of zinc oxide and silicon oxide, for example, represented by formula ZnxSiyOz (0≦x≦1, 0≦y≦1 and 0<z≦3). Additionally, the composite graded refractive index layer 140 has refractive index values which reduce from the first surface 160 to the second surface 180, ranging from 1.46 to 2.3.

In this embodiment, the electronic device 300 is an organic light-emitting diode (OLED) device comprising a first electrode 320, a light-emitting layer 340 and a second electrode 360. The first electrode 320 may comprise indium tin oxide (ITO). The second electrode 360 may comprise metal. Therefore, in this embodiment, the electronic device 300 is a bottom-emitting device.

In this embodiment, the encapsulation structure 100 further comprises a second composite graded refractive index layer 140′ formed on the electronic device 300, as shown in FIG. 6-1.

The second composite graded refractive index layer 140′ comprises varying compositions of zinc oxide and silicon oxide, for example, represented by formula ZnxSiyOz (0≦x≦1, 0≦y≦1 and 0<z≦3).

Specifically, the composite graded refractive index layer 140 and the second composite graded refractive index layer 140′ have a water vapor transmission rate (WVTR) of less than 5×10⁻³ g/m²/day.

Referring to FIG. 7, in accordance with one embodiment of the disclosure, an encapsulation structure is provided. An encapsulation structure 100′ comprises a substrate 120, a composite graded refractive index layer 140 and an electronic device 300. The substrate 120 may be a glass substrate. The composite graded refractive index layer 140 has a first surface 160 where light penetrates thereinto and a second surface 180 where light exits therefrom. The composite graded refractive index layer 140 is formed on the substrate 120. The electronic device 300 is disposed between the first surface 160 of the composite graded refractive index layer 140 and the substrate 120. Specifically, the composite graded refractive index layer 140 comprises varying compositions of zinc oxide and silicon oxide, for example, represented by formula ZnxSiyOz (0≦x≦1, 0≦y≦1 and 0<z≦3). Additionally, the composite graded refractive index layer 140 has refractive index values which reduce from the first surface 160 to the second surface 180, ranging from 1.46 to 2.3.

In this embodiment, the electronic device 300 is an organic light-emitting diode (OLED) device comprising a first electrode 320, a light-emitting layer 340 and a second electrode 360. The first electrode 320 may comprise indium tin oxide (ITO). The second electrode 360 may comprise metal. Therefore, in this embodiment, the electronic device 300 is a top-emitting device.

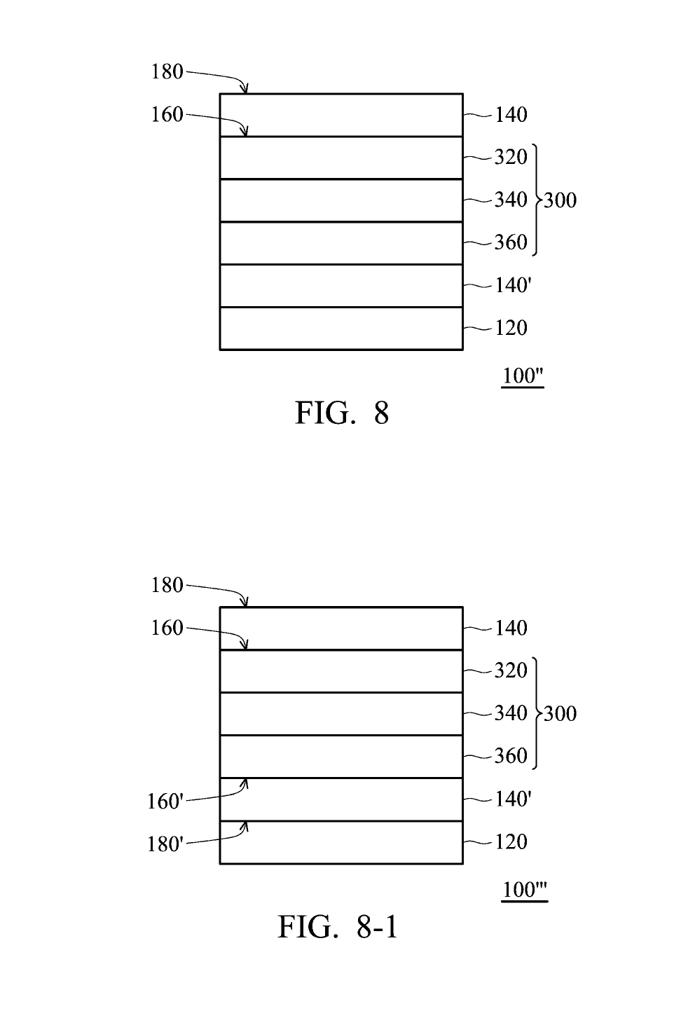

Referring to FIG. 8, in accordance with one embodiment of the disclosure, an encapsulation structure is provided. An encapsulation structure 100″ comprises a substrate 120, a composite graded refractive index layer 140 and an electronic device 300. The substrate 120 may be a glass substrate. The composite graded refractive index layer 140 has a first surface 160 where light penetrates thereinto and a second surface 180 where light exits therefrom. The composite graded refractive index layer 140 is formed on the substrate 120. The electronic device 300 is disposed between the first surface 160 of the composite graded refractive index layer 140 and the substrate 120. Specifically, the composite graded refractive index layer 140 comprises varying compositions of zinc oxide and silicon oxide, for example, represented by formula ZnxSiyOz (0≦x≦1, 0≦y≦1 and 0<z≦3). Additionally, the composite graded refractive index layer 140 has refractive index values which reduce from the first surface 160 to the second surface 180, ranging from 1.46 to 2.3.

In this embodiment, the electronic device 300 is an organic light-emitting diode (OLED) device comprising a first electrode 320, a light-emitting layer 340 and a second electrode 360. The first electrode 320 may comprise indium tin oxide (ITO). The second electrode 360 may comprise metal. Therefore, in this embodiment, the electronic device 300 is a top-emitting device.

In this embodiment, the encapsulation structure 100″ further comprises a second composite graded refractive index layer 140′ formed between the electronic device 300 and the substrate 120. Specifically, the second composite graded refractive index layer 140′ comprises varying compositions of zinc oxide and silicon oxide, for example, represented by formula ZnxSiyOz (0≦x≦1, 0≦y≦1 and 0<z≦3).

Specifically, the composite graded refractive index layer 140 and the second composite graded refractive index layer 140′ have a water vapor transmission rate (WVTR) less than 5×10⁻³ g/m²/day.

Referring to FIG. 8-1, in accordance with one embodiment of the disclosure, an encapsulation structure is provided. An encapsulation structure 100′″ comprises a substrate 120, a composite graded refractive index layer 140 and an electronic device 300. The substrate 120 may be a glass substrate. The composite graded refractive index layer 140 has a first surface 160 where light penetrates thereinto and a second surface 180 where light exits therefrom. The composite graded refractive index layer 140 is formed on the substrate 120. The electronic device 300 is disposed between the first surface 160 of the composite graded refractive index layer 140 and the substrate 120. Specifically, the composite graded refractive index layer 140 comprises varying compositions of zinc oxide and silicon oxide, for example, represented by formula ZnxSiyOz (0≦x≦1, 0≦y≦1 and 0<z≦3). Additionally, the composite graded refractive index layer 140 has refractive index values which reduce from the first surface 160 to the second surface 180, ranging from 1.46 to 2.3.

In this embodiment, the electronic device 300 is an organic light-emitting diode (OLED) device comprising a first electrode 320, a light-emitting layer 340 and a second electrode 360. When the first electrode 320 and the second electrode 360 are indium tin oxide (ITO), the electronic device 300 emits light from a top and a bottom thereof.

In this embodiment, the encapsulation structure 100′″ further comprises a second composite graded refractive index layer 140′ formed between the electronic device 300 and the substrate 120. The second composite graded refractive index layer 140′ has a first surface 160′ where light penetrates thereinto and a second surface 180′ where light exits therefrom. In this embodiment, the electronic device 300 is disposed between the first surface 160 of the composite graded refractive index layer 140 and the first surface 160′ of the second composite graded refractive index layer 140′. Specifically, the second composite graded refractive index layer 140′ comprises varying compositions of zinc oxide and silicon oxide, for example, represented by formula ZnxSiyOz (0≦x≦1, 0≦y≦1 and 0<z≦3). Additionally, the second composite graded refractive index layer 140′ has refractive index values which reduce from the first surface 160′ to the second surface 180′, ranging from 1.46 to 2.3.

Specifically, the composite graded refractive index layer 140 and the second composite graded refractive index layer 140′ have a water vapor transmission rate (WVTR) less than 5×10⁻³ g/m²/day.

A method for preparing a composite graded refractive index layer is disclosed as follows, taking co-sputtering technology as an example. First, argon (flow rate: 10 sccm) is conducted into a vacuum chamber. The sputtering power of zinc oxide (ZnO) and silicon dioxide (SiO2) is modulated under a working pressure of 5 mtorr and a substrate temperature of 25° C. to plate a multiple-layer graded-refractive-index ZnxSiyOz compound layer from zinc oxide (ZnO) and silicon dioxide (SiO2) targets with various refractive indexes. The sputtering power of zinc oxide (ZnO) is modulated within a range from 0 to 1,000 W. The sputtering power of silicon dioxide (SiO2) is modulated within a range from 0 to 1,000 W.

The disclosure provides a light extraction structure applied to OLED devices, adopting two kinds of oxides (zinc oxide (ZnO) and silicon dioxide (SiO2)) as targets having a refractive index difference which is comparatively large to create a composite graded refractive index (GRI) layer, mainly ZnxSiyOz inorganic oxide layer, through modulation of sputtering power of zinc oxide (ZnO) and silicon dioxide (SiO2). The composite graded refractive index layer has refractive index values which reduce from the surface where light penetrates thereinto and to the surface where light exits therefrom. On one hand, adopting the property of the graded refractive index of the composite graded refractive index layer can efficiently lower the loss of critical angle of incident light when the light enters to the composite graded refractive index layer from a transparent conductive layer, for instance ITO. On the other hand, the composite graded refractive index layer with low water vapor transmission rate (<0.01 g/m²-day) can also block intrusive water vapor/oxygen and tremendously improve light output of an OLED device. Also, the composite graded refractive index layer of the disclosure can be continuously fabricated in the same chamber by adopting co-sputtering technology which avoids particulate pollution when transferring wafers in the general manufacturing process and achieves the purpose of time-saving, yield-increasing and cost-saving. Also, the transmittance rate of visible light of the entire encapsulation structure of the disclosure can achieve 95%, for an extremely high light transmittance rate.

### Example 1

### Range of the Refractive Index of the Graded Refractive Index (GRI) Layer

The range of the refractive index of the graded refractive index layer (ZnxSiyOz compound layer) prepared by applying various sputtering powers of zinc oxide (ZnO) and silicon dioxide (SiO2) is shown in Table 1.

TABLE 1

| Sputtering power | Sputtering power | | |
|---|---|---|---|
| of ZnO | of SiO2 | Zn/(Zn + Si) | Refractive index |
| (W) | (W) | (%) | (at 460 nm) |
| 125 | 100 | 83.32 | 1.94 |
| 125 | 125 | 82.96 | 1.89 |
| 125 | 150 | 80.49 | 1.82 |
| 100 | 150 | 71.78 | 1.78 |
| 75 | 150 | 58.01 | 1.67 |
| 25 | 150 | 34.68 | 1.62 |

In accordance with Table 1, the range of the refractive index of the graded refractive index layer (ZnxSiyOz compound layer) prepared by applying various sputtering powers of zinc oxide (ZnO) and silicon dioxide (SiO2) was wide.

### Example 2

### Transmittance Rate of the Graded Refractive Index (GRI) Layer

The transmittance rate of the graded refractive index layer (ZnxSiyOz compound layer) prepared by applying various sputtering powers of zinc oxide (ZnO) and silicon dioxide (SiO2) is shown in Table 2.

TABLE 2

| Sputtering | Sputtering | | | | |
|---|---|---|---|---|---|
| power | power | Transmittance | | | |
| of ZnO | of SiO2 | rate (460 nm) | Oxygen | Zinc | Silicon |
| (W) | (W) | (%) | (%) | (%) | (%) |
| 125 | 150 | 95 | 48.69 | 41.30 | 10.01 |
| 125 | 125 | 94 | 49.06 | 42.26 | 8.68 |
| 125 | 100 | 95 | 46.34 | 44.71 | 8.95 |
| 100 | 150 | 99 | 50.78 | 35.3 | 13.89 |
| 75 | 150 | 99 | 51.55 | 27.99 | 20.26 |
| 40 | 150 | 96 | 51.70 | 25.28 | 23.02 |
| 25 | 150 | 96 | 57.03 | 14.90 | 28.07 |

In accordance with Table 2, the transmittance rate of the graded refractive index layer (ZnxSiyOz compound layer) prepared by applying various sputtering powers of zinc oxide (ZnO) and silicon dioxide (SiO2) was high, achieving above 94%.

### Example 3

### Effect on Improvement of Critical Angle of Incident Light by the Composite Graded Refractive Index (GRI) Layer I

Referring to FIG. 2, incident light penetrated into the first refractive layer 20 (having the first refractive index n1) and exited from the second refractive layer 22 (having the second refractive index n2). The first refractive index n1 was larger than the second refractive index n2. In accordance with Formula I (n1: refractive index of incident port; n2: refractive index of exiting port; θc: critical angle) and Formula II (d: thickness of the refractive layer; λ: wavelength; n: refractive index; m: non-zero integer (such as 1, 2, and 3 etc., here m=1)) (the thickness of the refractive layer required to meet this formula to avoid light reflection), when n1 was 1.694 and n2 was 1.594, after calculation, the thickness of the first refractive layer 20 was 70.1 nm and the thickness of the second refractive layer 22 was 74.5 nm. The critical angle of the incident light was increased from 56 degrees to above 70.2 degrees. The result effectively reduced the optical waveguide effect within a light-emitting layer/transparent conductive layer of an OLED.

$$\begin{matrix}{θ}_{c} = {sin}^{- 1} ( \frac{{n}_{2}}{{n}_{1}} ) & Formula I \\ d = m λ / 4 n & Formula II\end{matrix}$$

### Example 4

### Effect on Improvement of Critical Angle of Incident Light by the Composite Graded Refractive Index (GRI) Layer II

Referring to FIG. 3, incident light penetrated into the first refractive layer 20 (having the first refractive index n1), passed through the second refractive layer 22 (having the second refractive index n2) and exited from the third refractive layer 24 (having the third refractive index n3). The first refractive index n1 was larger than the second refractive index n2. The second refractive index n2 was larger than the third refractive index n3. In accordance with Formula I (n1: refractive index of incident port; n2: refractive index of exiting port; θc: critical angle) and Formula II (d: thickness of the refractive layer; λ: wavelength; n: refractive index; m: non-zero integer (such as 1, 2, and 3 etc., here m=1)) (the thickness of the refractive layer required to meet this formula to avoid light reflection), when n1 was 1.725, n2 was 1.65 and n3 was 1.575, after calculation, the thickness of the first refractive layer 20 was 68.9 nm, the thickness of the second refractive layer 22 was 72 nm and the thickness of the third refractive layer 24 was 75.4 nm. The critical angle of the incident light was increased from 56 degrees to above 73 degrees. The result effectively reduced the optical waveguide effect within a light-emitting layer/transparent conductive layer of an OLED.

### Example 5

### Effect on Improvement of Critical Angle of Incident Light by the Composite Graded Refractive Index (GRI) Layer III

Referring to FIG. 4, incident light penetrated into the first refractive layer 20 (having the first refractive index n1), passed through the second refractive layer 22 (having the second refractive index n2) and the third refractive layer 24 (having the third refractive index n3), and exited from the fourth refractive layer 26 (having the fourth refractive index n4). The first refractive index n1 was larger than the second refractive index n2. The second refractive index n2 was larger than the third refractive index n3. The third refractive index n3 was larger than the fourth refractive index n4. In accordance with Formula I (n1: refractive index of incident port; n2: refractive index of exiting port; θc: critical angle) and Formula II (d: thickness of the refractive layer; λ: wavelength; n: refractive index; m: non-zero integer (such as 1, 2, and 3 etc., here m=1)) (the thickness of the refractive layer required to meet this formula to avoid light reflection), when n1 was 1.74, n2 was 1.68, n3 was 1.62 and n4 was 1.56, after calculation, the thickness of the first refractive layer 20 was 69 nm, the thickness of the second refractive layer 22 was 70.7 nm, the thickness of the third refractive layer 24 was 73.3 nm and the thickness of the fourth refractive layer 26 was 76.1 nm. The critical angle of the incident light was increased from 56 degrees to above 75 degrees. The result effectively reduced the optical waveguide effect within a light-emitting layer/transparent conductive layer of an OLED.

### Example 6

### Effect on Improvement of Critical Angle of Incident Light by the Composite Graded Refractive Index (GRI) Layer IV

Referring to FIG. 5, incident light penetrated into the first refractive layer 20 (having the first refractive index n1), passed through the second refractive layer 22 (having the second refractive index n2), the third refractive layer 24 (having the third refractive index n3) and the fourth refractive layer 26 (having the fourth refractive index n4), and exited from the fifth refractive layer 28 (having the fifth refractive index n5). The first refractive index n1 was larger than the second refractive index n2. The second refractive index n2 was larger than the third refractive index n3. The third refractive index n3 was larger than the fourth refractive index n4. The fourth refractive index n4 was larger than the fifth refractive index n5. In accordance with Formula I (n1: refractive index of incident port; n2: refractive index of exiting port; θc: critical angle) and Formula II (d: thickness of the refractive layer; λ: wavelength; n: refractive index; m: non-zero integer (such as 1, 2, and 3 etc., here m=1)) (the thickness of the refractive layer required to meet this formula to avoid light reflection), when n1 was 1.75, n2 was 1.7, n3 was 1.65, n4 was 1.6 and n5 was 1.55, after calculation, the thickness of the first refractive layer 20 was 67.9 nm, the thickness of the second refractive layer 22 was 69.9 nm, the thickness of the third refractive layer 24 was 72 nm, the thickness of the fourth refractive layer 26 was 74.2 nm and the thickness of the fifth refractive layer 28 was 76.6 nm. The critical angle of the incident light was increased from 56 degrees to above 76 degrees. The result effectively reduced the optical waveguide effect within a light-emitting layer/transparent conductive layer of an OLED.

### Example 7

### Light Extraction Efficiency of the Encapsulation Structure

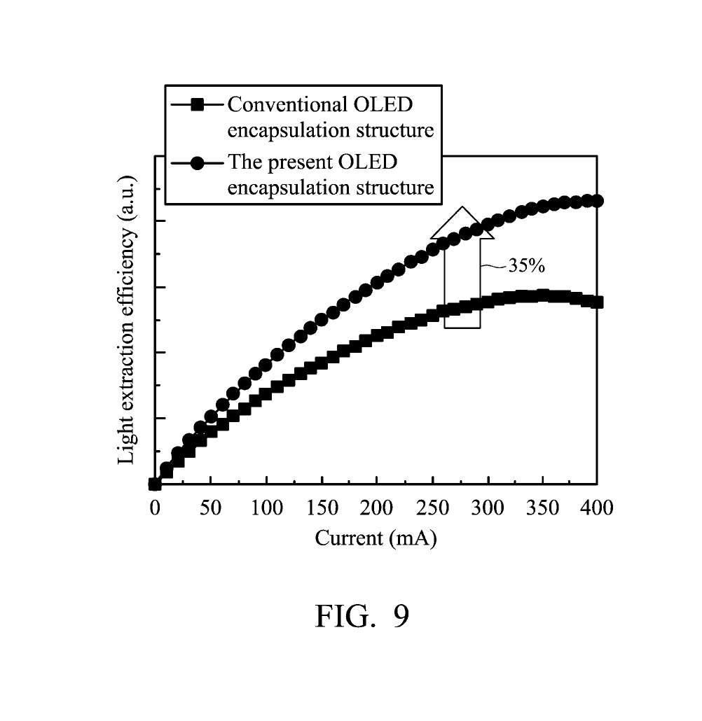

Referring to FIGS. 4 and 6, the comparison of the light extraction efficiency between the present OLED encapsulation structure of FIG. 6 (with the composite graded refractive index (GRI) layer of FIG. 4) and a conventional OLED encapsulation structure (without a composite graded refractive index (GRI) layer) is shown in FIG. 9.

In accordance with FIG. 9, compared to the conventional OLED encapsulation structure, the light extraction efficiency of the present OLED encapsulation structure was significantly improved to about above 35%.

### Example 8

### Water Vapor Transmission Rate (WVTR) of the Composite Graded Refractive Index (GRI) Layer

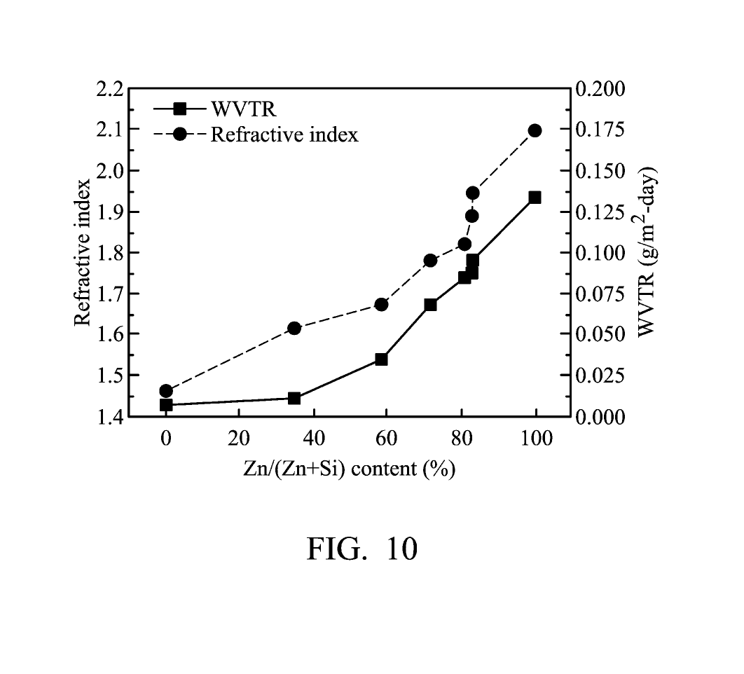

In this example, the water vapor transmission rate (WVTR) of a single-layer ZnxSiyOz compound layer with varying ratios of zinc and silicon was measured using a commercial instrument—MOCON. The results are shown in FIG. 10.

In accordance with FIG. 10, with the increase in the content of the silicon dioxide (SiO2) in the ZnxSiyOz compound layer, the water vapor transmission rate thereof was reduced. Specifically, when four ZnxSiyOz compound layers were stacked to form a four-layer composite graded refractive index (GRI) layer, the water vapor transmission rate thereof was merely about 10⁻³ g/m²/day which is the measurement limit of the instrument—MOCON.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A composite graded refractive index (GRI) layer structure, comprising:
a substrate; and
a composite graded refractive index layer with varying compositions of zinc oxide and silicon oxide formed on the substrate, wherein the composite graded refractive index layer has a first surface where light penetrates thereinto and a second surface where light exits therefrom, and the composite graded refractive index layer has refractive index values which reduce from the first surface to the second surface.

2. The composite graded refractive index (GRI) layer structure as claimed in claim 1, wherein the varying compositions of zinc oxide and silicon oxide are represented by formula ZnxSiyOz, wherein 0≦x≦1, 0≦y≦1 and 0<z≦3.

3. The composite graded refractive index (GRI) layer structure as claimed in claim 1, wherein the composite graded refractive index layer has a refractive index of 1.46-2.3.

4. The composite graded refractive index (GRI) layer structure as claimed in claim 1, wherein the composite graded refractive index layer comprises a first refractive layer comprising the first surface having a first refractive index and a second refractive layer comprising the second surface having a second refractive index, wherein the first refractive index is larger than the second refractive index.

5. The composite graded refractive index (GRI) layer structure as claimed in claim 1, wherein the composite graded refractive index layer comprises a first refractive layer comprising the first surface having a first refractive index, a second refractive layer having a second refractive index and a third refractive layer comprising the second surface having a third refractive index, wherein the first refractive index is larger than the second refractive index and the second refractive index is larger than the third refractive index.

6. The composite graded refractive index (GRI) layer structure as claimed in claim 1, wherein the composite graded refractive index layer comprises a first refractive layer comprising the first surface having a first refractive index, a second refractive layer having a second refractive index, a third refractive layer having a third refractive index and a fourth refractive layer comprising the second surface having a fourth refractive index, wherein the first refractive index is larger than the second refractive index, the second refractive index is larger than the third refractive index and the third refractive index is larger than the fourth refractive index.

7. The composite graded refractive index (GRI) layer structure as claimed in claim 1, wherein the composite graded refractive index layer comprises a first refractive layer comprising the first surface having a first refractive index, a second refractive layer having a second refractive index, a third refractive layer having a third refractive index, a fourth refractive layer having a fourth refractive index and a fifth refractive layer comprising the second surface having a fifth refractive index, wherein the first refractive index is larger than the second refractive index, the second refractive index is larger than the third refractive index, the third refractive index is larger than the fourth refractive index and the fourth refractive index is larger than the fifth refractive index.

8. An encapsulation structure, comprising:
a substrate;
a composite graded refractive index layer with varying compositions of zinc oxide and silicon oxide formed on the substrate, wherein the composite graded refractive index layer has a first surface where light penetrates thereinto and a second surface where light exits therefrom, and the composite graded refractive index layer has refractive index values which reduce from the first surface to the second surface; and
an electronic device disposed on the first surface of the composite graded refractive index layer.

9. The encapsulation structure as claimed in claim 8, wherein the varying compositions of zinc oxide and silicon oxide are represented by formula ZnxSiyOz, wherein 0≦x≦1, 0≦y≦1 and 0<z≦3.

10. The encapsulation structure as claimed in claim 8, wherein the composite graded refractive index layer has a refractive index of 1.46-2.3.

11. The encapsulation structure as claimed in claim 8, further comprising a second composite graded refractive index layer formed on the electronic device.

12. The encapsulation structure as claimed in claim 11, wherein the second composite graded refractive index layer comprises varying compositions of zinc oxide and silicon oxide.

13. The encapsulation structure as claimed in claim 12, wherein the varying compositions of zinc oxide and silicon oxide are represented by formula ZnxSiyOz, wherein 0≦x≦1, 0≦y≦1 and 0<z≦3.

14. An encapsulation structure, comprising:
a substrate;
a first composite graded refractive index layer with varying compositions of zinc oxide and silicon oxide formed on the substrate, wherein the first composite graded refractive index layer has a first surface where light penetrates thereinto and a second surface where light exits therefrom, and the first composite graded refractive index layer has refractive index values which reduce from the first surface to the second surface; and
an electronic device disposed between the first surface of the first composite graded refractive index layer and the substrate.

15. The encapsulation structure as claimed in claim 14, wherein the varying compositions of zinc oxide and silicon oxide are represented by formula ZnxSiyOz, wherein 0≦x≦1, 0≦y≦1 and 0<z≦3.

16. The encapsulation structure as claimed in claim 14, wherein the first composite graded refractive index layer has a refractive index of 1.46-2.3.

17. The encapsulation structure as claimed in claim 14, further comprising a second composite graded refractive index layer formed between the electronic device and the substrate.

18. The encapsulation structure as claimed in claim 17, wherein the second composite graded refractive index layer comprises varying compositions of zinc oxide and silicon oxide.

19. The encapsulation structure as claimed in claim 18, wherein the varying compositions of zinc oxide and silicon oxide are represented by formula ZnxSiyOz, wherein 0≦x≦1, 0≦y≦1 and 0<z≦3.

20. The encapsulation structure as claimed in claim 14, wherein the electronic device is a device which emits light from a top and a bottom thereof.

21. The encapsulation structure as claimed in claim 20, further comprising a second composite graded refractive index layer formed between the electronic device and the substrate, wherein the second composite graded refractive index layer with varying compositions of zinc oxide and silicon oxide has a first surface where light penetrates thereinto and a second surface where light exits therefrom, and the second composite graded refractive index layer has refractive index values which reduce from the first surface to the second surface.

22. The encapsulation structure as claimed in claim 21, wherein the electronic device is disposed between the first surface of the first composite graded refractive index layer and the first surface of the second composite graded refractive index layer.

23. The encapsulation structure as claimed in claim 21, wherein the second composite graded refractive index layer has a refractive index of 1.46-2.3.
